(19) United States
(12) Patent Application Publication
(10) Pub. No.: US 2021/0130092 A1
(43) Pub. Date: May 6, 2021

(54) WAREHOUSE, AND STORAGE OBJECT AND STORAGE RACK PROCESSING METHOD FOR WAREHOUSE

(71) Applicant: CAINIAO SMART LOGISTICS HOLDING LIMITED, GRAND CAYMAN (KY)

(72) Inventors: Haoyuan HU, HANGZHOU (CN); Longfei WANG, HANGZHOU (CN)

(21) Appl. No.: 17/088,010

(22) Filed: Nov. 3, 2020

Related U.S. Application Data
(63) Continuation of application No. PCT/CN2019/084517, filed on Apr. 26, 2019.

(30) Foreign Application Priority Data
May 9, 2018 (CN) 201810439524.9

(51) Int. Cl. B65G 1/10; G06Q 10/08

(52) U.S. Cl. CPC B65G 1/10; G06Q 10/087

(57) ABSTRACT

A warehouse, methods for processing a warehouse storage object, and a warehouse shelf are provided. The warehouse includes a multilayer shelf including shelf layers for storing storage objects. Each shelf layer is divided into multiple first loading spaces. The first loading spaces in a same shelf layer are connected in a horizontal direction, and the first loading spaces in different shelf layers are connected in a vertical direction. The first loading spaces form parallel storage object channels that form storage object circulation channels. Each storage object circulation channel comprises two parallel storage object channels. Conveyance directions of two adjacent storage object channels are opposite. First loading spaces at each end of the two storage object channels are joined to form a storage object circulation channel. Each storage object circulation channel comprises at least one first picking space and allow the storage objects to move in the storage object circulation channels.

### CROSS-REFERENCE TO RELATED APPLICATIONS

This application is a continuation application of International Patent Application No. PCT/CN2019/084517, filed with the China National Intellectual Property Administration (CNIPA) on Apr. 26, 2019, which is based on and claims priority to and benefit of Chinese Patent Application No. 201810439524.9, filed with the CNIPA on May 9, 2018. The entire contents of all of the above-identified applications are incorporated herein by reference.

### TECHNICAL FIELD

This specification relates to the field of warehouse technologies, and in particular, to a warehouse, a method for processing a warehouse storage object, and a method for processing a warehouse shelf.

### BACKGROUND

Automated warehouse is a type of warehouse that can achieve the automatic storing and fetching merchandise. Currently, automated warehouses have been adopted by more and more logistics enterprises, and have a significant effect on reducing the labor costs and improving the operation efficiency.

Rental cost is one of the main components of warehouse operation costs. Therefore, increasing the density of merchandise shelf and the warehouse space utilization is very important to reduce the warehouse operation costs.

Current mainstream automated warehouse schemes including automated stereoscopic warehouses and mobile robot-based automated warehouses all have the problems of a complex system and low space utilization.

### SUMMARY

In view of the foregoing problems, embodiments of this specification provide a warehouse, a method for processing a warehouse storage object, and a method for processing a warehouse shelf, to overcome the foregoing problems and to provide various technical benefits.

The embodiments of this specification provide a warehouse, including: a multilayer shelf for storing storage objects placed in the multilayer shelf. Each shelf layer is divided into a plurality of first loading spaces capable of accommodating storage objects. First loading spaces of the same shelf layer are connected in a horizontal direction, and first loading spaces of different shelf layers are connected in a vertical direction. First loading spaces of the multilayer shelf form a plurality of parallel storage object channels. Conveyance directions of two adjacent storage object channels are opposite, and first loading spaces at two ends of the storage object channels are connected to jointly constitute a storage object circulation channel. Each storage object circulation channel includes at least one first picking space. The storage object moves in the storage object circulation channel.

In one embodiment, each storage object circulation channel further includes at least one first replenishment space.

In one embodiment, the first loading spaces of the multilayer shelf form a plurality of parallel horizontal storage object channels in the horizontal direction. Conveyance directions of two adjacent horizontal storage object channels in the horizontal direction are opposite, and first loading spaces at two ends of the horizontal storage object channels are connected to jointly constitute a first storage object circulation channel. The storage object moves in the first storage object circulation channel.

In one embodiment, the first loading spaces of the multilayer shelf form a plurality of parallel horizontal storage object channels in the horizontal direction. Conveyance directions of two horizontal storage object channels adjacent in the vertical direction are opposite, and first loading spaces at two ends of the horizontal storage object channels are connected to jointly constitute a second storage object circulation channel. The storage object moves in the second storage object circulation channel.

In one embodiment, the first loading spaces of the multilayer shelf form a plurality of parallel vertical storage object channels in the vertical direction. Conveyance directions of two adjacent vertical storage object channels in the vertical direction are opposite, and first loading spaces at two ends of the vertical storage object channels are connected to jointly constitute a third storage object circulation channel. The storage object moves in the third storage object circulation channel.

In one embodiment y, the horizontal storage object channel is provided with a first horizontal moving apparatus, and the first horizontal moving apparatus is configured to drive the storage object to move between adjacent first loading spaces in the horizontal direction.

In one embodiment, a bottom of the storage object is provided with a first drive apparatus configured to drive the storage object to move.

In one embodiment, the horizontal storage object channel is provided with a first horizontal moving apparatus, and first loading spaces at two ends of the horizontal storage object channel are provided with first vertical moving apparatuses. The first vertical moving apparatuses are configured to drive the storage object to move between adjacent first loading spaces in the vertical direction.

In one embodiment, a bottom of the storage object is provided with a first drive apparatus configured to drive the storage object to move, and first loading spaces at two ends of the horizontal storage object channel are provided with first vertical moving apparatuses.

In one embodiment, the vertical storage object channel is provided with a first vertical moving apparatus, and first loading spaces at two ends of the vertical storage object channel are provided with first horizontal moving apparatuses.

In one embodiment, the vertical storage object channel is provided with a first vertical moving apparatus, and a bottom of the storage object is provided with a first drive apparatus configured to drive the storage object to move.

In one embodiment, at least one of first loading spaces at two ends of the horizontal storage object channel is a first picking space and/or a first replenishment space.

In one embodiment, a first loading space at a top end of the vertical storage object channel is a first picking space and/or a first replenishment space.

In one embodiment, a first loading space at a bottom end of the vertical storage object channel is a first picking space and/or a first replenishment space.

In a first further aspect of this specification, a warehouse is provided. The warehouse comprises a multilayer shelf that comprises a plurality of shelf layers for storing a plurality of storage objects. Each shelf layer is divided into a plurality of first loading spaces for storing the storage objects. One or more of the first loading spaces that are in a same shelf layer of the multilayer shelf are connected in a horizontal direction. One or more of the first loading spaces that are in different shelf layers of the multilayer shelf are connected in a vertical direction. The plurality of first loading spaces of the multilayer shelf forms a plurality of parallel storage object channels, the plurality of parallel storage object channels forming a plurality of storage object circulation channels. Each of the storage object circulation channels comprises two storage object channels of the plurality of parallel storage object channels, conveyance directions of the two adjacent storage object channels are opposite, and first loading spaces at each end of the two storage object channels are connected such that the two storage object channels are joined to form the storage object circulation channel. Each of the plurality of storage object circulation channels comprises at least one first picking space, and the plurality of storage object circulation channels allow the storage objects to move in the storage object circulation channels.

In one embodiment, each of the storage object circulation channels further comprises at least one first replenishment space.

In one embodiment, at least one of the plurality of storage object circulation channels comprises: two horizontal storage object channels arranged horizontally on a same shelf layer of the multilayer shelf; two horizontal storage object channels arranged vertically on two shelf layers of the multilayer shelf; or two vertical storage object channels.

In one embodiment, at least one of the plurality of storage object circulation channels comprises two horizontal storage object channels arranged horizontally on a same shelf layer of the multilayer shelf, and each of the two horizontal storage object channels comprises a first horizontal moving apparatus, the first horizontal moving apparatus being configured to drive a storage object to move between adjacent first loading spaces in the horizontal direction.

In one embodiment, a bottom of each of the plurality of storage objects is provided with a first drive apparatus configured to drive the storage object to move.

In one embodiment, at least one of the plurality of storage object circulation channels comprises two horizontal storage object channels arranged vertically on two shelf layers of the multilayer shelf, each of the two horizontal storage object channels comprises a first horizontal moving apparatus, the first horizontal moving apparatus being configured to drive a storage objects to move between adjacent first loading spaces in the horizontal direction, and first loading spaces at two ends of each horizontal storage object channel are provided with first vertical moving apparatuses, each of the first vertical moving apparatuses being configured to drive a storage object to move between adjacent first loading spaces in the vertical direction.

In one embodiment, at least one of the plurality of storage object circulation channels comprises two vertical storage object channels, each of the two vertical storage object channels comprises a first vertical moving apparatus, the first vertical moving apparatus being configured to drive a storage object to move between adjacent first loading spaces in the vertical direction, and first loading spaces at two ends of each vertical storage object channel are provided with first horizontal moving apparatuses, each of the first horizontal moving apparatuses being configured to drive a storage object to move between adjacent first loading spaces in the horizontal direction.

In one embodiment, for each of the storage object circulation channels, a first loading space at an end of one of the two storage object channels is the first picking space or the first replenishment space.

The embodiments of this specification further disclose a method for processing a warehouse storage object. The warehouse includes a multilayer shelf for storing storage objects placed in the multilayer shelf. Each shelf layer is divided into a plurality of first loading spaces for storing storage objects. First loading spaces of the same shelf layer are connected in a horizontal direction, and first loading spaces of different shelf layers are connected in a vertical direction. First loading spaces of the multilayer shelf form a plurality of parallel storage object channels. Conveyance directions of two adjacent storage object channels are opposite, and first loading spaces at two ends of the storage object channels are connected to jointly constitute a storage object circulation channel. Each storage object circulation channel includes at least one first picking space. The method includes: controlling, when a storage object in the storage object circulation channel moves to the first picking space, the storage object to stop moving to perform a picking operation; and controlling, after the picking operation is completed, the storage object to move.

In an embodiment, each storage object circulation channel further includes at least one first replenishment space. The method further includes: controlling, when the storage object in the storage object circulation channel moves to the first replenishment space, the storage object to stop moving to perform a replenishment operation; and controlling, after the replenishment operation is completed, the storage object to move.

In a second further aspect of this specification, a method for processing a storage object in a warehouse is provided. The warehouse comprises a multilayer shelf that comprises a plurality of shelf layers for storing a plurality of storage objects. Each shelf layer is divided into a plurality of first loading spaces for storing the storage objects. One or more of the first loading spaces that are in a same shelf layer of the multilayer shelf are connected in a horizontal direction. One or more of the first loading spaces that are in different shelf layers of the multilayer shelf are connected in a vertical direction. The plurality of first loading spaces of the multilayer shelf forms a plurality of parallel storage object channels, the plurality of parallel storage object channels forming a plurality of storage object circulation channels. Each of the storage object circulation channels comprises two storage object channels of the plurality of parallel storage object channels, conveyance directions of the two adjacent storage object channels are opposite, and first loading spaces at each end of the two storage object channels are connected such that the two storage object channels are joined to form the storage object circulation channel. Each of the plurality of storage object circulation channels comprises at least one first picking space. The method comprises: controlling, when a storage object in one of the storage object circulation channels moves to a first picking space of the storage object circulation channel, the storage object to stop moving to perform a picking operation; and controlling, after the picking operation is completed, the storage object to move.

The embodiments of this specification further disclose a warehouse, including a multilayer platform for accommodating a movable shelf disposed on each layer of platform. Each platform layer is divided into a plurality of second loading spaces for accommodating shelves. Second loading spaces of the same platform layer are connected in a horizontal direction, and second loading spaces of different platform layers are connected in a vertical direction. Second loading spaces of the multilayer platform form a plurality of parallel shelf channels. Conveyance directions of two adjacent shelf channels are opposite, and second loading spaces at two ends of the shelf channels are connected to jointly constitute a shelf circulation channel. Each shelf circulation channel includes at least one second picking space. The shelf moves in the shelf circulation channel.

In an embodiment, each shelf circulation channel further includes at least one second replenishment space.

In an embodiment, the second loading spaces of the multilayer platform form a plurality of horizontal shelf channels in the horizontal direction. Conveyance directions of two adjacent horizontal shelf channels in the horizontal direction are opposite, and second loading spaces at two ends of the horizontal shelf channels are connected to jointly constitute a first shelf circulation channel. The shelf moves in the first shelf circulation channel.

In an embodiment, the second loading spaces of the multilayer platform form a plurality of horizontal shelf channels in the horizontal direction. Conveyance directions of two horizontal shelf channels adjacent in the vertical direction are opposite, and second loading spaces at two ends of the horizontal shelf channels are connected to jointly constitute a second shelf circulation channel. The shelf moves in the second shelf circulation channel.

In an embodiment, the second loading spaces of the multilayer platform form a plurality of vertical shelf channels in the vertical direction. Conveyance directions of two adjacent vertical shelf channels in the vertical direction are opposite, and second loading spaces at two ends of the vertical shelf channels are connected to jointly constitute a third shelf circulation channel. The shelf moves in the third shelf circulation channel.

In an embodiment, the horizontal shelf channel is provided with a second horizontal moving apparatus, and the second horizontal moving apparatus is configured to drive the shelf to move between adjacent second loading spaces in the horizontal direction.

In an embodiment, a bottom of the shelf is provided with a second drive apparatus configured to drive the shelf to move. Preferably, the horizontal shelf channel is provided with a second horizontal moving apparatus, and second loading spaces at two ends of the horizontal shelf channel are provided with second vertical moving apparatuses. The second vertical moving apparatuses are configured to drive the shelf to move between adjacent second loading spaces in the vertical direction.

In an embodiment, a bottom of the shelf is provided with a second drive apparatus configured to drive the shelf to move, and second loading spaces at two ends of the horizontal shelf channel are provided with second vertical moving apparatuses.

In an embodiment, the vertical shelf channel is provided with a second vertical moving apparatus, and second loading spaces at two ends of the vertical shelf channel are provided with second horizontal moving apparatuses.

In an embodiment, the vertical shelf channel is provided with a second vertical moving apparatus, and a bottom of the shelf is provided with a second drive apparatus configured to drive the shelf to move.

In an embodiment, at least one of second loading spaces at two ends of the horizontal shelf channel is a second picking space and/or a second replenishment space.

In an embodiment, a second loading space at a top end of the vertical shelf channel is a second picking space and/or a second replenishment space.

In an embodiment, a second loading space at a bottom end of the vertical shelf channel is a second picking space and/or a second replenishment space.

In a third further aspect of this specification, a warehouse is provided. The warehouse comprises a multilayer platform that comprises a plurality of platform layers for accommodating a plurality of shelves. Each platform layer is divided into a plurality of second loading spaces for accommodating the shelves. One or more of the second loading spaces that are in a same platform layer of the multilayer platform are connected in a horizontal direction, and one or more of the second loading spaces that are in different platform layers of the multilayer platform are connected in a vertical direction. The plurality of second loading spaces of the multilayer platform forms a plurality of parallel shelf channels, the plurality of parallel shelf channels forming a plurality of shelf circulation channels. Each of the shelf circulation channels comprises two shelf channels of the plurality of parallel shelf channels, conveyance directions of the two adjacent shelf channels are opposite, and second loading spaces at each end of the two shelf channels are connected such that the two shelf channels are joined to form the shelf circulation channel. Each of the plurality of shelf circulation channels comprises at least one second picking space, and the plurality of shelf circulation channels allow the shelves to move in the shelf circulation channels.

The embodiments of this specification further disclose a method for processing a warehouse shelf. The warehouse includes a multilayer platform for accommodating a movable shelf disposed on each layer of platform. Each platform layer is divided into a plurality of second loading spaces for accommodating shelves. Second loading spaces of the same platform layer are connected in a horizontal direction, and second loading spaces of different platform layers are connected in a vertical direction. Second loading spaces of the multilayer platform form a plurality of parallel shelf channels. Conveyance directions of two adjacent shelf channels are opposite, and second loading spaces at two ends of the shelf channels are connected to jointly constitute a shelf circulation channel. Each shelf circulation channel includes at least one second picking space. The method includes: controlling, when a shelf in the shelf circulation channel moves to the second picking space, the shelf to stop moving to perform a picking operation; and controlling, after the picking operation is completed, the shelf to move.

In an embodiment, each shelf circulation channel further includes at least one second replenishment space. The method further includes: controlling, when the shelf in the shelf circulation channel moves to the second replenishment space, the shelf to stop moving to perform a replenishment operation; and controlling, after the replenishment operation is completed, the shelf to move.

In a fourth further aspect of this specification, a method for processing a shelf in a warehouse is provided. The warehouse comprises a multilayer platform that comprises a plurality of platform layers for accommodating a plurality of shelves. Each platform layer is divided into a plurality of second loading spaces for accommodating the shelves. One or more of the second loading spaces that are in a same platform layer of the multilayer platform are connected in a horizontal direction, and one or more of the second loading spaces that are in different platform layers of the multilayer platform are connected in a vertical direction. The plurality of second loading spaces of the multilayer platform forms a plurality of parallel shelf channels, the plurality of parallel shelf channels forming a plurality of shelf circulation channels. Each of the shelf circulation channels comprises two shelf channels of the plurality of parallel shelf channels, conveyance directions of the two adjacent shelf channels are opposite, and second loading spaces at each end of the two shelf channels are connected such that the two shelf channels are joined to form the shelf circulation channel. Each of the plurality of shelf circulation channels comprises at least one second picking space. The method comprises: controlling, when a shelf in one of the plurality of shelf circulation channels moves to a second picking space of one of the plurality of shelf circulation channels, the shelf to stop moving to perform a picking operation; and controlling, after the picking operation is completed, the shelf to move.

The embodiments of this specification include the following advantages.

In the embodiments of this specification, a warehouse includes a multilayer shelf, each shelf layer is divided into a plurality of first loading spaces for accommodating storage objects, the first loading spaces are adjacent to each other, and each first loading space may accommodate at least one storage object. With such a warehouse, the storage density for storage objects can be increased, and the space utilization can be improved. The first loading spaces may form a storage object channel in a horizontal direction, so that a storage object can be moved in the horizontal direction. For example, a storage object channel is formed in the horizontal direction from front to back, or a storage object channel is formed in the horizontal direction from left to right. The first loading spaces may also form a storage object channel in a vertical direction, so that a storage object can be moved in the vertical direction. The warehouse in the embodiments of this specification can achieve a plurality of moving modes for a storage object, and the moving modes are simple and easy to maintain.

### BRIEF DESCRIPTION OF THE DRAWINGS

FIG. 1 is a structural diagram of a warehouse, according to a first embodiment of this specification.

FIG. 2 is a structural diagram of a first storage object circulation channel in a first example of the warehouse in the first embodiment, according to an embodiment of this specification.

FIG. 3 is a structural diagram of a second storage object circulation channel in a second example of the warehouse in the first embodiment, according to an embodiment of this specification.

FIG. 4 is a structural diagram of a third storage object circulation channel in a third example of the warehouse in the first embodiment, according to an embodiment of this specification.

FIG. 5 is a flowchart of steps of a method for processing a storage object in a warehouse, according to an embodiment of this specification.

FIG. 6 is a structural diagram of a warehouse, according to a second embodiment of this specification.

FIG. 7 is a structural diagram of a first shelf circulation channel in a first example of the warehouse in the second embodiment, according to an embodiment of this specification.

FIG. 8 is a structural diagram of a second shelf circulation channel in a second example of the warehouse in the second embodiment, according to an embodiment of this specification.

FIG. 9 is a structural diagram of a third shelf circulation channel in a third example of the warehouse in the second embodiment, according to an embodiment of this specification.

FIG. 10 is a flowchart of steps of a method for processing a shelf in a warehouse, according to an embodiment of this specification.

### DETAILED DESCRIPTION OF THE INVENTION

To enable the foregoing objectives, features, and advantages of this specification to be clearer and more comprehensive, the following further describes this specification in detail with reference to the accompanying drawings and specific implementations.

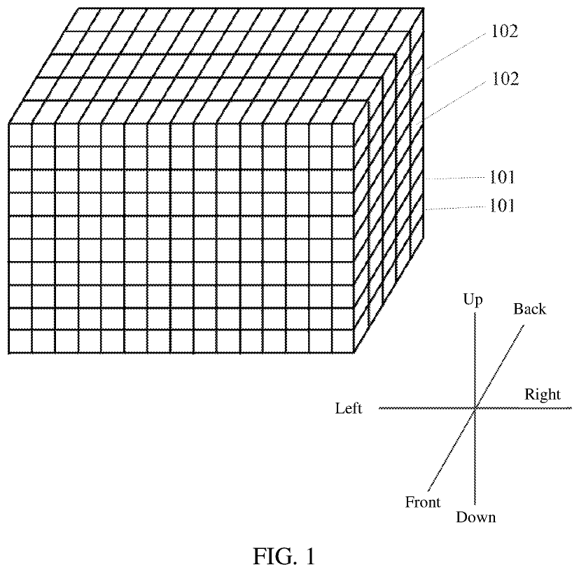

FIG. 1 is a structural diagram of a warehouse, according to a first embodiment of this specification. The warehouse includes a multilayer shelf for storing storage objects placed in the multilayer shelf. Each shelf layer 101 is divided into a plurality of first loading spaces 102 for accommodating the storage objects. First loading spaces 102 of the same shelf layer 101 are connected in a horizontal direction, and first loading spaces 102 of different shelf layers 101 are connected in a vertical direction. First loading spaces 102 of the multilayer shelf form a plurality of parallel storage object channels. Conveyance directions of two adjacent storage object channels are opposite, and first loading spaces at two ends of the storage object channels are connected to each other and jointly constitute a storage object circulation channel. Each storage object circulation channel includes at least one first picking space.

The storage object moves in the storage object circulation channel.

In this embodiment of this specification, the multilayer shelf includes a plurality of shelf layers 101, and each shelf layer 101 is divided into a plurality of first loading spaces 102. As shown in FIG. 1, a space grid is a first loading space 102, and the first loading spaces 102 are closely arranged. Each first loading space 102 may accommodate at least one storage object. The storage object may be a storage box. A top surface of the storage box has an opening for loading or fetching merchandise.

The plurality of first loading spaces 102 of the multilayer shelf may form a plurality of parallel storage object channels, and the first loading spaces 102 forming a storage object channel are all connected. The storage objects may be conveyanced in the storage object channels. Conveyance directions of two adjacent storage object channels are opposite. First loading spaces 102 at each end of the storage object channels are connected such that two storage object channels are joined to form one or more storage object circulation channels. When a storage object moves to the first loading space 102 at an end of a storage object channel, the storage object may further move to a first loading space 102 at an end of an adjacent storage object channel. Each storage object circulation channel includes at least one first picking space. When a storage object (including to-be-picked merchandise) moves to the first picking space, a picking operator may perform a picking operation on the storage object in the first picking space. The first picking space may be a first loading space 102.

In this embodiment of this specification, a warehouse includes a multilayer shelf, each shelf layer 101 is divided into a plurality of first loading spaces 102 for accommodating storage objects. The first loading spaces 102 are immediately adjacent to each other, and each first loading space 102 may accommodate at least one storage object. The storage density for storage objects in such a warehouse can be increased, and the space utilization can be improved. The first loading spaces 102 may form storage object channels in a horizontal direction, so that a storage object can be moved in the horizontal direction. For example, a storage object channel is formed in the horizontal direction from front to back, or a storage object channel is formed in the horizontal direction from left to right. The first loading spaces 102 may also form storage object channels in a vertical direction, so that a storage object can be moved in the vertical direction. The warehouse disclosed in this embodiment of this specification can achieve a plurality of moving modes for a storage object, and the moving modes are simple and easy to maintain.

In this embodiment of this specification, each storage object circulation channel further includes at least one first replenishment space. When a storage object (to-be-allocated target merchandise) moves to the first replenishment space, a replenishment operator places the target merchandise in the storage object in the first replenishment space. The first replenishment space may be a first loading space 102.

In the first example of the first embodiment of this specification, the first loading spaces 102 of the multilayer shelf form a plurality of parallel horizontal storage object channels in the horizontal direction. Conveyance directions of two adjacent horizontal storage object channels in the horizontal direction are opposite. The first loading spaces 102 at each end of the horizontal storage object channels are connected such that the storage object channels are joined to form first storage object circulation channels. The storage object moves in the first storage object circulation channels.

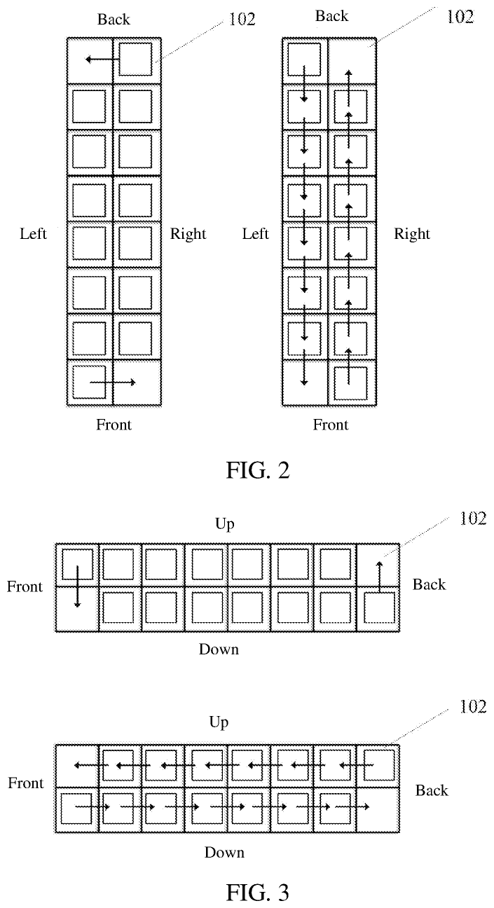

FIG. 2 is a structural diagram of the first storage object circulation channel in a first example of the warehouse in the first embodiment, according to an embodiment of this specification. The first loading spaces 102 of the multilayer shelf form horizontal storage object channels in the horizontal direction from front to back. Conveyance directions of two horizontal storage object channels that are adjacent in the horizontal direction are opposite. The first loading spaces 102 at each end of the horizontal storage object channels are connected such that the horizontal storage object channels are joined to form the first storage object circulation channels. For example, a conveyance direction of the left horizontal storage object channel is from back to front, and the conveyance direction of back ends of the horizontal storage object channels are from right to left, and the conveyance direction of front ends of the horizontal storage object channels are from left to right. A conveyance direction of the right horizontal storage object channel is from front to back, and conveyance directions of first loading spaces at front ends of the horizontal storage object channels are from left to right and conveyance directions of first loading spaces at back ends of the horizontal storage object channels are from right to left respectively.

In the first example, the horizontal storage object channel may comprise or be provided with a first horizontal moving apparatus, and the first horizontal moving apparatus is configured to drive the storage object to move between adjacent first loading spaces 102 in the horizontal direction.

The first horizontal moving apparatus may be a conveyor belt installed in the horizontal storage object channel, or a driving apparatus installed in the horizontal storage object channel. The conveyor belt may be driven by a motor, and a storage object placed on the conveyor belt moves along with the conveyor belt. The driving apparatus may be an electrically or hydraulically driven push rod, and a pushing surface of the push rod may be in contact with the storage object, to push the storage object to move. Because storage objects are closely arranged (i.e., immediately adjacent to each other), when one storage object is pushed, the adjacent storage object also moves.

In addition to installation of the first horizontal moving apparatus in the horizontal storage object channel to enable the storage object to move in the horizontal direction, a first drive apparatus configured to drive the storage object to move may be installed at a bottom of the storage object. The first drive apparatus may be an apparatus having a drive motor and wheels, the wheels are driven by the motor, and the first drive apparatus may drive the storage object to move.

As shown in FIG. 2, first loading spaces 102 at front ends of the left and right horizontal storage object channels are first picking spaces. When a storage object (including to-be-picked merchandise) in the left horizontal storage object channel moves to the first picking space of the left horizontal storage object channel, a picking operation may be performed in the first picking space. Alternatively, the picking operation may be performed after the storage object moves rightward to the first picking space of the right horizontal storage object channel. After the picking operator completing picking from the storage object in the first picking space, the storage object may be controlled to move from the front to the back in the right horizontal storage object channel. After the storage object in the right horizontal storage object channel moves to a first loading space 102 at the back end of the right horizontal storage object channel, the storage object may move from right to left to the first loading space 102 at the back end of the left horizontal storage object channel. By repeating the foregoing process, the storage object may circularly move in the first storage object circulation channel. In the first example, at least one of first loading spaces 102 at two ends of the horizontal storage object channel is a first picking space and/or a first replenishment space. The first picking space may be the first loading space 102 at the front end of the horizontal storage object channel, and the first replenishment space may also be the first loading space 102 at the front end of the horizontal storage object channel. That is, the first replenishment space and the first picking space may be the same first loading space 102. Alternatively, the first replenishment space may be the first loading space 102 at the back end of the horizontal storage object channel. That is, the first replenishment space and the first picking space are different first loading spaces 102.

In a second example of this embodiment of this specification, the first loading spaces of the multilayer shelf form a plurality of parallel horizontal storage object channels in the horizontal direction. Conveyance directions of two horizontal storage object channels adjacent in the vertical direction are opposite, and first loading spaces at each end of the horizontal storage object channels are connected such that the horizontal storage object channels are joined to form a second storage object circulation channel. The storage object moves in the second storage object circulation channel.

FIG. 3 is a structural diagram of the second storage object circulation channel in a second example of the warehouse in the first embodiment, according to this specification. The first loading spaces 102 of the multilayer shelf form horizontal storage object channels in the horizontal direction from front to back. Conveyance directions of two horizontal storage object channels that are adjacent in the vertical direction are opposite, and first loading spaces 102 at each end of the horizontal storage object channels are connected such that the horizontal storage object channels are joined to form the second storage object circulation channel. For example, a conveyance direction of an upper horizontal storage object channel is from back to front, and the conveyance direction of the back ends of the horizontal storage object channels is upward and the conveyance direction of the front end of the horizontal storage object channel is downward.

A conveyance direction of a lower horizontal storage object channel is from front to back, and conveyance direction of first loading spaces 102 at front ends of the horizontal storage object channels are downward and conveyance direction of first loading spaces 102 at the back ends of the horizontal storage object channels is upward.

In the second example, the horizontal storage object channel comprises or is provided with a first horizontal moving apparatus, and first loading spaces 102 at both ends of the horizontal storage object channel are provided with first vertical moving apparatuses. The first vertical moving apparatuses are configured to drive the storage object to move between adjacent first loading spaces 102 in the vertical direction. Because the two horizontal storage object channels adjacent in the vertical direction form the second storage object circulation channel, the first vertical moving apparatuses need to be provided to move the storage object between the two horizontal storage object channels vertically.

In addition to installation of the first horizontal moving apparatus in the horizontal storage object channel to move the storage object in the horizontal direction, a first drive apparatus configured to drive the storage object to move may be installed at a bottom of the storage object.

As shown in FIG. 3, first loading spaces 102 at front ends of the upper and lower horizontal storage object channels may comprise first picking spaces. When a storage object (including to-be-picked merchandise) in the upper horizontal storage object channel moves to a first picking space of the upper horizontal storage object channel, a picking operation may be performed in the first picking space. Alternatively, the picking operation may be performed after the storage object moves downward to a first picking space of the lower horizontal storage object channel. After the picking operator completing picking from the storage object in the first picking space, the storage object may be controlled to move from front to back in the lower horizontal storage object channel. After the storage object in the lower horizontal storage object channel moves to a first loading space 102 at the back end of the lower horizontal storage object channel, the storage object may move upward to a first loading space 102 at the back end of the upper horizontal storage object channel. By repeating the foregoing process, the storage object may circularly move in the second storage object circulation channel. In the second example, at least one of first loading spaces 102 at both ends of the horizontal storage object channel is a first picking space and/or a first replenishment space. The first picking space may be a first loading space 102 at the front end of the horizontal storage object channel, and the first replenishment space may also be the first loading space 102 at the front end of the horizontal storage object channel. That is, the first replenishment space and the first picking space may be the same first loading space 102. Alternatively, the first replenishment space may be a first loading space 102 at the back end of the horizontal storage object channel. That is, the first replenishment space and the first picking space are different first loading spaces 102 of the horizontal storage object channel.

In the third example of this embodiment of this specification, the first loading spaces of the multilayer shelf form a plurality of parallel vertical storage object channels in the vertical direction. Conveyance directions of two adjacent vertical storage object channels in the vertical direction are opposite, and first loading spaces at each end of the vertical storage object channels are connected such that the two vertical storage object channels are joined to form a third storage object circulation channel. The storage object moves in the third storage object circulation channel.

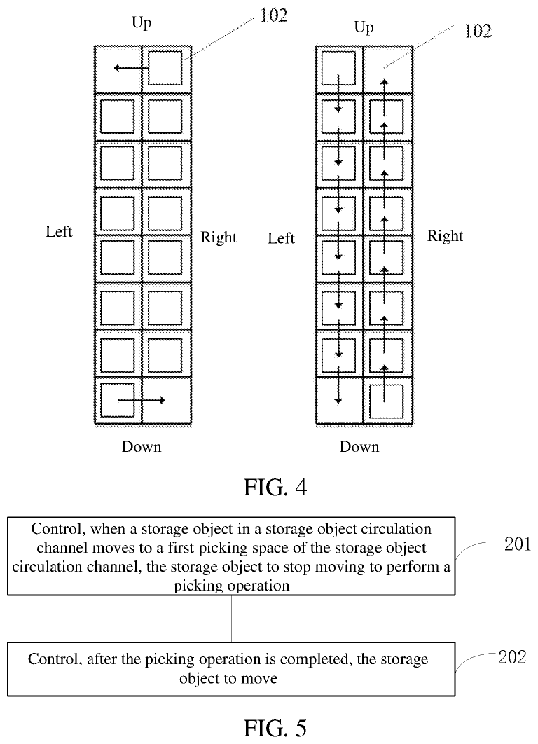

FIG. 4 is a structural diagram of the third storage object circulation channel in a third example of the warehouse in the first embodiment, according to this specification. The first loading spaces 102 of the multilayer shelf form vertical storage object channels in the vertical direction. Conveyance directions of two vertical storage object channels that are adjacent in the vertical direction are opposite, and first loading spaces 102 at each end of the vertical storage object channels are connected such that the vertical storage object channels are joined to form the third storage object circulation channel. For example, a conveyance direction of a left vertical storage object channel is downward, and the conveyance direction of top ends of the vertical storage object channels is from right to left and the conveyance direction of bottom ends of the vertical storage object channels is from left to right. A conveyance direction of a right vertical storage object channel is upward, and conveyance direction of first loading spaces 102 at bottom ends of the vertical storage object channels is from left to right and conveyance direction of first loading spaces 102 at top ends of the vertical storage object channels is from right to left.

In the third example, the vertical storage object channel may comprise or be provided with a first vertical moving apparatus, and first loading spaces 102 at both ends of the vertical storage object channel are provided with first horizontal moving apparatuses. The first vertical moving apparatus drives the storage object to move upward or downward in the vertical storage object channel. Because the two parallel vertical storage object channels adjacent in the vertical direction form the third storage object circulation channel, the first vertical moving apparatus and the first horizontal moving apparatuses need to be installed to move the storage object between the two vertical storage object channels.

In addition to installation of the first horizontal moving apparatuses in the vertical storage object channel to move the storage object in the horizontal direction, a first drive apparatus configured to drive the storage object to move may be installed at a bottom of the storage object. The first drive apparatus may drive the storage object to move in the horizontal direction from a first loading space 102 of one vertical storage object channel to a first loading space 102 of the other vertical storage object channel.

As shown in FIG. 4, first loading spaces 102 at top ends of the left and right vertical storage object channels are first picking spaces. When a storage object (including to-be-picked merchandise) in the right vertical storage object channel moves to a first picking space of the right vertical storage object channel, a picking operation may be performed in the first picking space. Alternatively, the picking operation may be performed after the storage object moves leftward to a first picking space of the left vertical storage object channel. After the picking operator completing picking from the storage object in the first picking space, the storage object may be controlled to move downward in the left vertical storage object channel. After the storage object in the left vertical storage object channel moves to a first loading space 102 at the bottom end of the left vertical storage object channel, the storage object may move from left to right to a first loading space 102 at the bottom end of the right vertical storage object channel. By repeating the foregoing process, the storage object may circularly move in the third storage object circulation channel. In the third example, a first loading space 102 at the top end of the vertical storage object channel is a first picking space and/or a first replenishment space. The first picking space may be the first loading space 102 at the top end of the vertical storage object channel, and the first replenishment space may also be the first loading space 102 at the top end of the vertical storage object channel. That is, the first replenishment space and the first picking space may be the same first loading space 102.

In the third example, a first loading space 102 at the bottom end of the vertical storage object channel is a first picking space and/or a first replenishment space. The first picking space may be the first loading space 102 at the bottom end of the vertical storage object channel, and the first replenishment space may also be the first loading space 102 at the bottom end of the vertical storage object channel. That is, the first replenishment space and the first picking space may be the same first loading space 102.

FIG. 5 is a flowchart of steps of a method for processing a warehouse storage object, according to this specification. The warehouse may include a multilayer shelf for storing storage objects placed in the multilayer shelf. Each shelf layer is divided into a plurality of first loading spaces for accommodating storage objects. First loading spaces of the same shelf layer may be connected in a horizontal direction, and first loading spaces of different shelf layers may also be connected in a vertical direction. First loading spaces of the multilayer shelf form a plurality of parallel storage object channels. Conveyance directions of two adjacent storage object channels are opposite, and first loading spaces at each end of the storage object channels are connected such that the storage object channels are joined to form a storage object circulation channel. Each storage object circulation channel includes at least one first picking space. The method may include the following steps.

Step 201, control, when a storage object in the storage object circulation channel moves to the first picking space of the storage object circulation channel, the storage object to stop moving to perform a picking operation.

When a storage object including to-be-picked merchandise in the storage object circulation channel moves to the first picking space, the storage object is controlled to stop moving. A picking operator may perform a picking operation on the storage object in the first picking space.

Step 202, control, after the picking operation is completed, the storage object to move.

After the picking operator completes picking the merchandise in the storage object, the picking operator may trigger a picking completion confirmation signal to control the storage object to move out of the first picking space, and a next storage object right behind it may move to the first picking space.

In this embodiment of this specification, each storage object circulation channel further includes at least one first replenishment space. The method may further include: controlling, when the storage object in the storage object circulation channel moves to the first replenishment space of the storage object circulation channel, the storage object to stop moving to perform a replenishment operation; and controlling, after the replenishment operation is completed, the storage object to move.

When the storage object moves to the first replenishment space of the storage object circulation channel, the storage object is controlled to stop moving. A replenishment operator may perform a replenishment operation on the storage object in the first replenishment space.

After the replenishment operator completes replenishing the storage object, the replenishment operator may trigger a replenishment completion confirmation signal, to control the storage object to move out of the first replenishment space, and a next storage object right behind it may move to the first replenishment space.

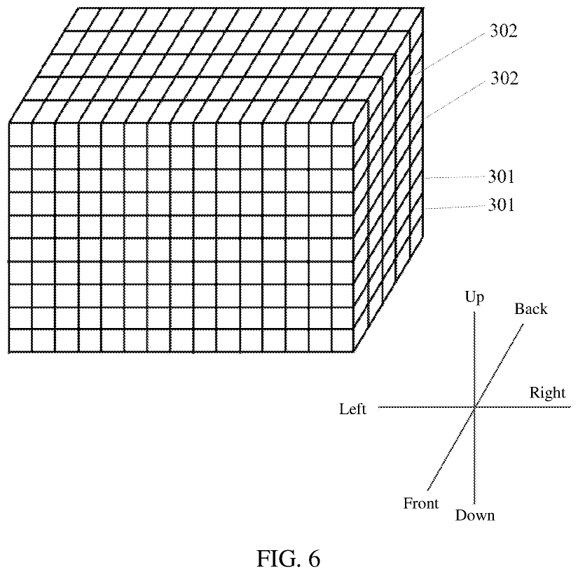

FIG. 6 is a structural diagram of the warehouse, according to a second embodiment of this specification. The warehouse may include a multilayer platform comprises a plurality of platform layers for accommodating movable shelves disposed on platform layers of the platform. Each platform layer 301 is divided into a plurality of second loading spaces 302 for accommodating shelves. Second loading spaces 302 of the same platform layer 301 are connected in a horizontal direction, and second loading spaces 302 of different platform layers are connected in a vertical direction. Second loading spaces 302 of the multilayer platform form a plurality of parallel shelf channels. Conveyance directions of two adjacent shelf channels are opposite, and second loading spaces at each end of the shelf channels are connected such that the two shelf channels are joined to form a shelf circulation channel. Each shelf circulation channel includes at least one second picking space. The shelf moves in the shelf circulation channels.

In this embodiment of this specification, the multilayer platform includes a plurality of platform layers 301, and each platform layer 301 may be divided into a plurality of second loading spaces 302. As shown in FIG. 6, a space grid is a second loading space 302, and second loading spaces 302 are closely arranged. Each second loading space 302 may accommodate at least one shelf.

The plurality of second loading spaces 302 of the multilayer platform may form a plurality of parallel shelf channels, and the second loading spaces 302 forming the shelf channels are all connected. The shelves may be conveyanced in the shelf channels. Conveyance directions of two adjacent shelf channels are opposite, and second loading spaces 302 at each end of the shelf channels are connected such that the shelf channels are joined to form a shelf circulation channel. When a shelf moves to the second loading space 302 at an end of a shelf channel, the shelf may move to a second loading space 302 at an end of the adjacent shelf channel. Each shelf circulation channel includes at least one second picking space. When a shelf (including to-be-picked merchandise) moves to the second picking space, a picking operator may perform a picking operation on the shelf in the second picking space. The second picking space may be a second loading space 302.

In this embodiment of this specification, a warehouse includes a multilayer platform, each platform layer 301 may be divided into a plurality of second loading spaces 302 for accommodating shelves, second loading spaces 302 are adjacent, and each second loading space 302 may accommodate at least one shelf. With such a warehouse, the storage density for shelves can be improved, and the space utilization can be improved. The second loading spaces 302 may form a shelf channel in the horizontal direction, so that the shelf can be moved in the horizontal direction. For example, a shelf channel is formed in the horizontal direction from front to back, or a shelf channel is formed in the horizontal direction from left to right. The second loading spaces 302 may also form a shelf channel in a vertical direction, so that a shelf can be moved in the vertical direction. The warehouse in this embodiment of this specification can achieve a plurality of moving modes for a shelf, and the moving modes are simple and easy to maintain.

In this embodiment of this specification, each shelf circulation channel further includes at least one second replenishment space. When a shelf (including to-be-distributed target merchandise) moves to the second replenishment space, a replenishment operator places the target merchandise in the shelf in the second replenishment space. The second replenishment space may be a second loading space 302. In an example of this embodiment of this specification, the second loading spaces 302 of the multilayer platform form a plurality of horizontal shelf channels in the horizontal direction. Conveyance directions of two adjacent horizontal shelf channels in the horizontal direction are opposite, and second loading spaces 302 at both ends of the horizontal shelf channels are connected such that the horizontal shelf channels are joined to form a first shelf circulation channel. The shelf moves in the first shelf circulation channel.

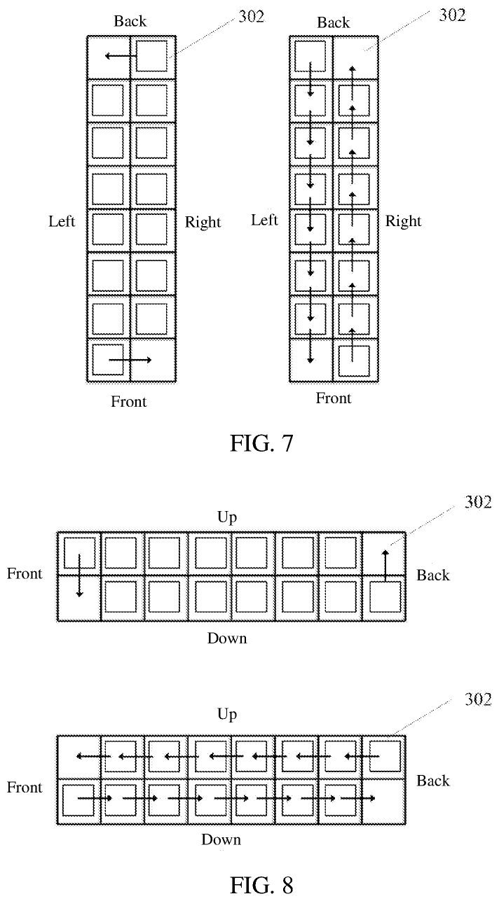

FIG. 7 is a structural diagram of the first shelf circulation channel in a first example of the warehouse in the second embodiment, according to this specification. The second loading spaces 302 of the multilayer platform form horizontal shelf channels in the horizontal direction from front to back. Conveyance directions of two horizontal shelf channels that are adjacent in the horizontal direction are opposite, and second loading spaces 302 at each end of the horizontal shelf channels are connected such that the horizontal shelf channels are joined to form the first shelf circulation channel. For example, a conveyance direction of the left horizontal shelf channel is from back to front, and the conveyance direction of back ends of the horizontal shelf channels is from right to left and the conveyance direction of front ends of the horizontal shelf channels is from left to right. A conveyance direction of the right horizontal shelf channel is from front to back, and conveyance directions of second loading spaces 302 at front ends of the horizontal shelf channels are from left to right and conveyance directions of second loading spaces 302 at back ends of the horizontal shelf channels are from right to left.

In the first example, the horizontal shelf channel may comprise or be provided with a second horizontal moving apparatus, and the second horizontal moving apparatus is configured to drive the shelf to move between adjacent second loading spaces 302 in the horizontal direction.

The second horizontal moving apparatus may be a conveyor belt installed in the horizontal shelf channel, or a driving apparatus installed in the horizontal shelf channel. The conveyor belt may be driven by a motor, and a shelf placed on the conveyor belt moves along with the conveyor belt. The driving apparatus may be an electrically or hydraulically driven push rod, and a pushing surface of the push rod may be in contact with the shelf, to push the shelf to move. Because shelves are closely arranged, when one shelf is pushed, an adjacent shelf also moves.

In addition to installation of the second horizontal moving apparatus in the horizontal shelf channel to move the shelf in the horizontal direction, a second drive apparatus configured to drive the shelf to move may be disposed at a bottom of the shelf. The second drive apparatus may be an apparatus having a drive motor and wheels. The wheels are driven by the motor, and the second drive apparatus may drive the shelf to move.

As shown in FIG. 7, second loading space 302 at front ends of the left and right horizontal shelf channels are second picking spaces. When a shelf in the left horizontal shelf channel moves to a second picking space of the left horizontal shelf channel, a picking operation may be performed in the second picking space. Alternatively, the picking operation may be performed after the shelf moves rightward to a second picking space of the right horizontal shelf channel. After the picking operator completing picking from the shelf in the second picking space, the shelf may be controlled to move from front to back in the right horizontal shelf channel. After the shelf in the right horizontal shelf channel moves to a second loading space 302 at the back end of the right horizontal shelf channel, the shelf may move from right to left to a second loading space 302 at the back end of the left horizontal shelf channel. By repeating the foregoing process, the shelf may circularly move in the first shelf circulation channel.

In the first example, at least one of second loading spaces 302 at both ends of the horizontal shelf channel is a second picking space and/or a second replenishment space. The second picking space may be a second loading space 302 at a front end of the horizontal shelf channel, and the second replenishment space may also be the second loading space 302 at the front end of the horizontal shelf channel. That is, the second replenishment space and the second picking space may be the same second loading space 302. Alternatively, the second replenishment space may be a second loading space 302 at the back end of the horizontal shelf channel. That is, the second replenishment space and the second picking space are different second loading spaces 302.

In a second example of this embodiment of this specification, the second loading spaces 302 of the multilayer platform form a plurality of horizontal shelf channels in the horizontal direction. Conveyance directions of two horizontal shelf channels adjacent in the vertical direction are opposite, and second loading spaces 302 at each end of the horizontal shelf channels are connected such that the horizontal shelf channels are joined to form a second shelf circulation channel. The shelf moves in the second shelf circulation channel.

FIG. 8 is a structural diagram of the second shelf circulation channel in a second example of the warehouse in the second embodiment, according to this specification. The second loading spaces 302 of the multilayer platform form horizontal shelf channels in the horizontal direction from front to back. Conveyance directions of two horizontal shelf channels that are adjacent in the vertical direction are opposite, and second loading spaces 302 at each end of the horizontal shelf channels are connected such that the horizontal shelf channels are joined to form the second shelf circulation channel. For example, a conveyance direction of an upper horizontal shelf channel is from back to front, and the conveyance direction of back ends of the horizontal shelf channels is upward and the conveyance direction of front ends of the horizontal shelf channels is downward. A conveyance direction of a lower horizontal shelf channel is from front to back, and conveyance direction of second loading spaces 302 at front ends of the horizontal shelf channels is downward and conveyance direction of second loading spaces 302 at back ends of the horizontal shelf channels is upward.

In the second example, the horizontal shelf channel may comprise or be provided with a second horizontal moving apparatus, and second loading spaces 302 at both ends of the horizontal shelf channels are provided with second vertical moving apparatuses. The second vertical moving apparatuses are configured to drive the shelf to move between adjacent second loading spaces 302 in the vertical direction. Because the two horizontal shelf channels adjacent in the vertical direction form the second shelf circulation channel, the second vertical moving apparatuses need to be installed to move the shelf between the two horizontal shelf channels.

In addition to installation of the second horizontal moving apparatus in the horizontal shelf channel to move the shelf in the horizontal direction, a second drive apparatus configured to drive the shelf to move may be installed at a bottom of the shelf.

As shown in FIG. 8, second loading space 302 at front ends of the upper and lower horizontal shelf channels are second picking spaces. When a shelf in the upper horizontal shelf channel moves to a second picking space of the upper horizontal shelf channel, a picking operation may be performed in the second picking space. Alternatively, the picking operation may be performed after the shelf moves downward to a second picking space of the lower horizontal shelf channel. After the picking operator completing picking from the shelves in the second picking space, the shelf may be controlled to move from front to back in the lower horizontal shelf channel. After the shelf in the lower horizontal shelf channel moves to a second loading space 302 at the back end of the lower horizontal shelf channel, the shelf may move upward to a second loading space 302 at the back end of the upper horizontal shelf channel. By repeating the foregoing process, the shelf may circularly move in the second shelf circulation channel.

In the second example, at least one of second loading spaces 302 at both ends of the horizontal shelf channel is a second picking space and/or a second replenishment space. The second picking space may be a second loading space 302 at the front end of the horizontal shelf channel, and the second replenishment space may also be the second loading space 302 at the front end of the horizontal shelf channel. That is, the second replenishment space and the second picking space may be the same second loading space 302. Alternatively, the second replenishment space may be a second loading space 302 at the back end of the horizontal shelf channel. That is, the second replenishment space and the second picking space are different second loading spaces 302.

In a third example of this embodiment of this specification, the second loading spaces 302 of the multilayer platform form a plurality of vertical shelf channels in the vertical direction. Conveyance directions of two adjacent vertical shelf channels in the vertical direction are opposite, and second loading spaces 302 at each of the vertical shelf channels are connected such that the vertical shelf channels are joined to form a third shelf circulation channel. The shelf moves in the third shelf circulation channel.

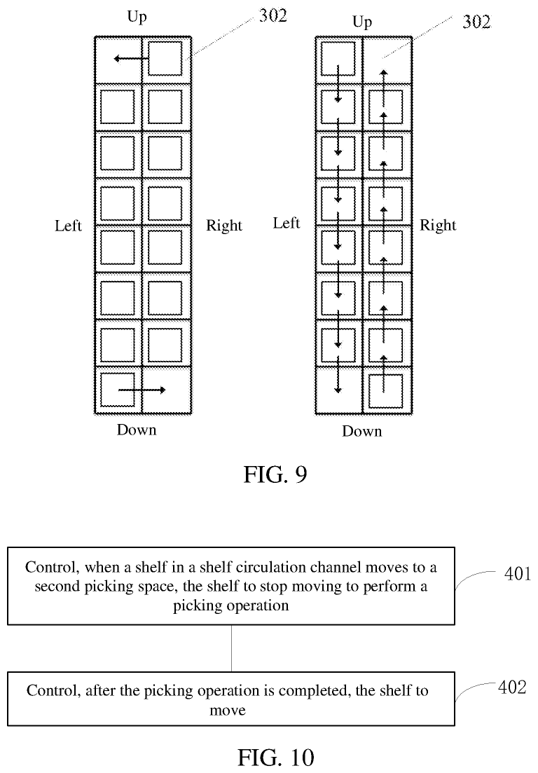

FIG. 9 is a structural diagram of the third shelf circulation channel in the third example of the warehouse in the second embodiment, according to this specification. The second loading spaces 302 of the multilayer platform form vertical shelf channels in the vertical direction. Conveyance directions of two adjacent vertical shelf channels in the vertical direction are opposite, and second loading spaces 302 at each end of the vertical shelf channels are connected such that the vertical shelf channels are joined to form the third shelf circulation channel. For example, a conveyance direction of the left vertical shelf channel is downward, and the conveyance direction of top ends of the vertical shelf channels is from right to left and the conveyance direction of bottom ends of the vertical shelf channels is from left to right. A conveyance direction of the right vertical shelf channel is upward, and conveyance direction of second loading spaces 302 at bottom ends of the vertical shelf channels is from left to right and conveyance directions of second loading spaces 302 at top ends of the vertical shelf channels is from right to left.

In the third example, the vertical shelf channel may comprises or be provided with a second vertical moving apparatus, and second loading spaces 302 at both ends of the vertical shelf channel are provided with second horizontal moving apparatuses. The second vertical moving apparatus drives the shelf to move upward or downward in the vertical shelf channel. Because the two parallel adjacent vertical shelf channels in the vertical direction form the third shelf circulation channel, the second horizontal moving apparatus and the second vertical moving apparatuses need to be installed to move the shelf between the two vertical shelf channels.

In addition to installation of the second horizontal moving apparatus in the vertical shelf channel to move the shelf in the horizontal direction, a second drive apparatus configured to drive the shelf to move may be installed at a bottom of the shelf. The second drive apparatus may drive the shelf to move in the horizontal direction from a second loading space 302 of one vertical shelf channel to a second loading space 302 of the other vertical shelf channel.

As shown in FIG. 9, second loading spaces 302 at top ends of the left and right vertical shelf channels are second picking spaces. When a shelf in the right vertical shelf channel moves to a second picking space of the right vertical shelf channel, a picking operation may be performed in the second picking space. Alternatively, the picking operation may be performed after the shelf moves leftward to a second picking space of the left vertical shelf channel. After the picking operator completing picking from the shelf in the second picking space, the shelf may be controlled to move from up to down in the left vertical shelf channel. After the shelf in the left vertical shelf channel moves to the second loading space 302 at the bottom end of the left vertical shelf channel, the shelf may move from left to right to the second loading space 302 at the bottom end of the right vertical shelf channel. By repeating the foregoing process, the shelf may circularly move in the third shelf circulation channel.

In the third example, a second loading space 302 at the top end of the vertical shelf channel may be a second picking space and/or a second replenishment space. The second picking space may be the second loading space 302 at the top end of the vertical shelf channel, and the second replenishment space may also be the second loading space 302 at the top end of the vertical shelf channel. That is, the second replenishment space and the second picking space may be the same second loading space 302.

In the third example, a second loading space 302 at a bottom end of the vertical shelf channel may be a second picking space and/or a second replenishment space. The second picking space may be the second loading space 302 at the bottom end of the vertical shelf channel, and the second replenishment space may also be the second loading space 302 at the bottom end of the vertical shelf channel. That is, the second replenishment space and the second picking space may be the same second loading space 302.

FIG. 10 is a flowchart of steps of a method for processing a warehouse shelf, according to an embodiment of this specification. The warehouse may include a multilayer platform including platform layers for accommodating movable shelves disposed on platform layers of the platform. Each platform layer is divided into a plurality of second loading spaces for accommodating shelves. Second loading spaces of the same platform layer are connected in a horizontal direction, and second loading spaces of different platform layers are connected in a vertical direction. Second loading spaces of the multilayer platform form a plurality of parallel shelf channels. Conveyance directions of two adjacent shelf channels are opposite, and second loading spaces at each end of the shelf channels are connected such that the shelf channels are joined to form a shelf circulation channel. Each shelf circulation channel includes at least one second picking space. The method may include the following steps.

Step 401, control, when a shelf in the shelf circulation channel moves to the second picking space, the shelf to stop moving to perform a picking operation.

When a shelf including to-be-picked merchandise in the shelf circulation channel moves to the second picking space, the shelf is controlled to stop moving. A picking operator may perform a picking operation on the shelf in the second picking space.

Step 402, control, after the picking operation is completed, the shelf to move.

After the picking operator completes picking the merchandise in the shelf, the picking operator may trigger a picking completion confirmation signal, to control the shelf to move, and a next shelf right behind moves to the second picking space.

In this embodiment of this specification, each shelf circulation channel further includes at least one second replenishment space. The method further includes: controlling, when the shelf in the shelf circulation channel moves to the second replenishment space, the shelf to stop moving to perform a replenishment operation; and controlling, after the replenishment operation is completed, the shelf to move. When the shelf moves to the second replenishment space, the shelf is controlled to stop moving. A replenishment operator may perform a replenishment operation on the shelf in the second replenishment space.

After the replenishment operator completes replenishing the shelf, the replenishment operator may trigger a replenishment completion confirmation signal, to control the shelf to move out of the second replenishment space, and a next shelf right behind it may move to the second replenishment space.

The embodiments in this specification are all described in a progressive manner. Description of each of the embodiments focuses on differences from other embodiments, and reference may be made to each other for the same or similar parts among the embodiments.

Persons skilled in the art should understand that, the embodiments of this specification may be provided as methods, apparatuses, or computer program products. Therefore, the embodiments of this specification may use a form of hardware only embodiments, software only embodiments, or embodiments with a combination of software and hardware. In addition, the embodiments of this specification may use a form of a computer program product implemented on one or more computer available storage media (including but not limited to a disk memory, a CD-ROM, an optical memory, and the like) including computer available program code.

The embodiments of this specification are described with reference to flowcharts and/or block diagrams of the method, a terminal device (a system), and the computer program product in the embodiments of this specification. It should be understood that computer program instructions may be used for implementing each process and/or each block in the flowcharts and/or the block diagrams and a combination of a process and/or a block in the flowcharts and/or the block diagrams. The computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the general-purpose computer or the processor of another programmable data processing device.

The computer program instructions may also be stored in a computer-readable memory that can guide a computer or another programmable data processing terminal device to work in a specific manner, so that the instructions stored in the computer-readable memory generate a product including an instruction apparatus. The instruction apparatus implements functions specified in one or more processes in the flowcharts and/or one or more blocks in the block diagrams.

The computer program instructions may also be loaded into a computer or another programmable data processing terminal device, so that a series of operation steps are performed on the computer or the another programmable terminal device, to generate computer-implemented processing. Therefore, the instructions executed on the computer or the another programmable terminal device provide steps for implementing the functions specified in one or more processes in the flowcharts and/or one or more blocks in the block diagrams.

Although example embodiments of this specification have been described, persons skilled in the art can make changes and modifications to the embodiments once they learn the basic inventive concept. Therefore, the following claims include the embodiments and all changes and modifications falling within the scope of the embodiments of this specification.

Finally, it should be noted that in the specification, relational terms such as first and second are used only to differentiate an entity or operation from another entity or operation, and do not require or imply that any actual relationship or sequence exists between these entities or operations. Moreover, the terms “include,” “comprise,” and any variants thereof are intended to cover a non-exclusive inclusion. Therefore, a process, a method, an object, or a terminal device that includes a series of elements not only includes such elements, but also includes other elements not specified expressly, or may include inherent elements of the process, the method, the object, or the terminal device. Unless otherwise specified, an element limited by “include a/an . . . ” does not exclude other same elements existing in the process, the method, the article, or the terminal device that includes the elements.

The warehouse, the method for a processing warehouse storage object, and the method for processing a warehouse shelf provided in this specification are described in detail above. The principle and implementations of this specification are described herein by using specific examples. The description of the foregoing embodiments is merely used for helping understand the method and core ideas of this specification. In addition, persons of ordinary skilled in the art can make variations to this specification in terms of the specific implementations and application scopes according to the ideas of this specification. Therefore, the content of this specification shall not be construed as a limitation to this specification.

What is claimed is:

1. A warehouse, comprising: a multilayer shelf that comprises a plurality of shelf layers for storing a plurality of storage objects, wherein:
each shelf layer is divided into a plurality of first loading spaces for storing the storage objects;
one or more of the first loading spaces that are in a same shelf layer of the multilayer shelf are connected in a horizontal direction;
one or more of the first loading spaces that are in different shelf layers of the multilayer shelf are connected in a vertical direction;
the plurality of first loading spaces of the multilayer shelf forms a plurality of parallel storage object channels, the plurality of parallel storage object channels forming a plurality of storage object circulation channels, wherein:
each of the storage object circulation channels comprises two storage object channels of the plurality of parallel storage object channels,
conveyance directions of the two adjacent storage object channels are opposite, and
first loading spaces at each end of the two storage object channels are connected such that the two storage object channels are joined to form the storage object circulation channel;
each of the plurality of storage object circulation channels comprises at least one first picking space; and
the plurality of storage object circulation channels allow the storage objects to move in the storage object circulation channels.

2. The warehouse according to claim 1, wherein each of the storage object circulation channels further comprises at least one first replenishment space.

3. The warehouse according to claim 1, wherein at least one of the plurality of storage object circulation channels comprises:
two horizontal storage object channels arranged horizontally on a same shelf layer of the multilayer shelf;
two horizontal storage object channels arranged vertically on two shelf layers of the multilayer shelf; or
two vertical storage object channels.

4. The warehouse according to claim 1, wherein:
at least one of the plurality of storage object circulation channels comprises two horizontal storage object channels arranged horizontally on a same shelf layer of the multilayer shelf; and
each of the two horizontal storage object channels comprises a first horizontal moving apparatus, the first horizontal moving apparatus being configured to drive a storage object to move between adjacent first loading spaces in the horizontal direction.

5. The warehouse according to claim 1, wherein:
a bottom of each of the plurality of storage objects is provided with a first drive apparatus configured to drive the storage object to move.

6. The warehouse according to claim 1, wherein:
at least one of the plurality of storage object circulation channels comprises two horizontal storage object channels arranged vertically on two shelf layers of the multilayer shelf;
each of the two horizontal storage object channels comprises a first horizontal moving apparatus, the first horizontal moving apparatus being configured to drive a storage objects to move between adjacent first loading spaces in the horizontal direction; and
first loading spaces at two ends of each horizontal storage object channel are provided with first vertical moving apparatuses, each of the first vertical moving apparatuses being configured to drive a storage object to move between adjacent first loading spaces in the vertical direction.

7. The warehouse according to claim 1, wherein:
at least one of the plurality of storage object circulation channels comprises two vertical storage object channels;
each of the two vertical storage object channels comprises a first vertical moving apparatus, the first vertical moving apparatus being configured to drive a storage object to move between adjacent first loading spaces in the vertical direction; and
first loading spaces at two ends of each vertical storage object channel are provided with first horizontal moving apparatuses, each of the first horizontal moving apparatuses being configured to drive a storage object to move between adjacent first loading spaces in the horizontal direction.

8. The warehouse of claim 2, wherein, for each of the storage object circulation channels:
a first loading space at an end of one of the two storage object channels is the first picking space or the first replenishment space.

9. A method for processing a storage object in a warehouse, wherein:
the warehouse comprises: a multilayer shelf that comprises a plurality of shelf layers for storing a plurality of storage objects, wherein:
each shelf layer is divided into a plurality of first loading spaces for storing the storage objects,
one or more of the first loading spaces that are in a same shelf layer of the multilayer shelf are connected in a horizontal direction,
one or more of the first loading spaces that are in different shelf layers of the multilayer shelf are connected in a vertical direction,
the plurality of first loading spaces of the multilayer shelf forms a plurality of parallel storage object channels, the plurality of parallel storage object channels forming a plurality of storage object circulation channels, wherein: (1) each of the storage object circulation channels comprises two storage object channels of the plurality of parallel storage object channels, (2) conveyance directions of the two adjacent storage object channels are opposite, (3) first loading spaces at each end of the two storage object channels are connected such that the two storage object channels are joined to form the storage object circulation channel, and (4) each of the plurality of storage object circulation channels comprises at least one first picking space; and
the method comprises:
controlling, when a storage object in one of the storage object circulation channels moves to a first picking space of the storage object circulation channel, the storage object to stop moving to perform a picking operation; and
controlling, after the picking operation is completed, the storage object to move.

10. The method according to claim 9, wherein:
each of the plurality of storage object circulation channels further comprises at least one first replenishment space; and
the method further comprises:
controlling, when the storage object in the one of the storage object circulation channels moves to a first replenishment space of the storage object circulation channel, the storage object to stop moving to perform a replenishment operation; and
controlling, after the replenishment operation is completed, the storage object to move.

11. A warehouse, comprising: a multilayer platform that comprises a plurality of platform layers for accommodating a plurality of shelves, wherein:
each platform layer is divided into a plurality of second loading spaces for accommodating the shelves;
one or more of the second loading spaces that are in a same platform layer of the multilayer platform are connected in a horizontal direction, and one or more of the second loading spaces that are in different platform layers of the multilayer platform are connected in a vertical direction;
the plurality of second loading spaces of the multilayer platform forms a plurality of parallel shelf channels, the plurality of parallel shelf channels forming a plurality of shelf circulation channels, wherein:
each of the shelf circulation channels comprises two shelf channels of the plurality of parallel shelf channels,
conveyance directions of the two adjacent shelf channels are opposite, and
second loading spaces at each end of the two shelf channels are connected such that the two shelf channels are joined to form the shelf circulation channel, and
each of the plurality of shelf circulation channels comprises at least one second picking space; and
the plurality of shelf circulation channels allow the shelves to move in the shelf circulation channels.

12. The warehouse according to claim 11, wherein each of the shelf circulation channels further comprises at least one second replenishment space.

13. The warehouse according to claim 11, wherein at least one of the plurality of shelf circulation channels comprises:
two horizontal shelf channels arranged horizontally on a same platform layer of the multilayer platform;
two horizontal shelf channels arranged vertically on two platform layers of the multilayer platform; or
two vertical shelf channels.

14. The warehouse according to claim 11, wherein
at least one of the plurality of shelf circulation channels comprises two horizontal shelf channels arranged horizontally on a same platform layer of the multilayer platform; and
each of the two horizontal shelf channels comprises a second horizontal moving apparatus, the second horizontal moving apparatus being configured to drive a shelf to move between adjacent second loading spaces in the horizontal direction.

15. The warehouse according to claim 11, wherein
a bottom of each of the plurality of shelves is provided with a second drive apparatus configured to drive the shelf to move.

16. The warehouse according to claim 11, wherein:
at least one of the plurality of shelf circulation channels comprises two horizontal shelf channels arranged vertically on two platform layers of the multilayer platform;
each of the two horizontal shelf channels comprises a second horizontal moving apparatus, the second horizontal moving apparatus being configured to drive a shelf to move between adjacent second loading spaces in the horizontal direction; and
second loading spaces at two ends of each horizontal shelf channel are provided with second vertical moving apparatuses, each of the second vertical moving apparatuses being configured to drive a shelf to move between adjacent second loading spaces in the vertical direction.

17. The warehouse according to claim 11, wherein
at least one of the plurality of shelf circulation channels comprises two vertical shelf channels;
each of the two vertical shelf channels comprises a second vertical moving apparatus, the second vertical moving apparatuses being configured to drive a shelf to move between adjacent second loading spaces in the vertical direction, and
second loading spaces at two ends of each vertical shelf channel are provided with second horizontal moving apparatuses, each of the second horizontal moving apparatuses being configured to drive a shelf to move between adjacent second loading spaces in the horizontal direction.

18. The warehouse according to claim 12, wherein for each of the shelf circulation channels,
a second loading space at an end of one of the two shelf channels is the second picking space or the second replenishment space.

19. A method for processing a shelf in a warehouse, wherein
the warehouse comprises: a multilayer platform that comprises a plurality of platform layers for accommodating a plurality of shelves, wherein each platform layer is divided into a plurality of second loading spaces for accommodating the shelves, one or more of the second loading spaces that are in a same platform layer of the multilayer platform are connected in a horizontal direction, one or more of the plurality of second loading spaces that are in different platform layers of the multilayer platform are connected in a vertical direction, and the plurality of second loading spaces of the multilayer platform forms a plurality of parallel shelf channels, the plurality of parallel shelf channels forming a plurality of shelf circulation channels, wherein: (1) each of the shelf circulation channels comprises two shelf channels of the plurality of parallel shelf channels, (2) conveyance directions of the two adjacent shelf channels are opposite, (3) second loading spaces at each end of the two shelf channels are connected such that the two shelf channels are joined to form the shelf circulation channel, and (4) each of the plurality of shelf circulation channels comprises at least one second picking space, and
the method comprises:
controlling, when a shelf in one of the shelf circulation channels moves to a second picking space of the shelf circulation channel, the shelf to stop moving to perform a picking operation; and
controlling, after the picking operation is completed, the shelf to move.

20. The method according to claim 19, wherein:
each of the plurality of shelf circulation channels further comprises at least one second replenishment space; and
the method further comprises:
controlling, when the shelf in the one of the shelf circulation channels moves to a second replenishment space of the shelf circulation channel, the shelf to stop moving to perform a replenishment operation; and
controlling, after the replenishment operation is completed, the shelf to move.
